(19) United States
(12) Patent Application Publication
(10) Pub. No.: US 2026/0145997 A1
(43) Pub. Date: May 28, 2026

(54) GLASS ARTICLE WITH IMPROVED SURFACE QUALITY

(71) Applicants: Schott AG, Mainz (DE); SCHOTT Glass Technologies (Suzhou) Co. Ltd., Suzhou, Jiangsu (CN)

(72) Inventors: Wei Xiao, Suzhou (CN); Ning Da, Suzhou (CN); Feng He, Suzhou (CN)

(73) Assignees: Schott AG, Mainz (DE); SCHOTT Glass Technologies (Suzhou) Co. Ltd., Suzhou (CN)

(21) Appl. No.: 18/716,011

(22) PCT Filed: Dec. 3, 2021
(86) PCT No.: PCT/CN2021/135314

§ 371 Date: Jun. 3, 2024

(51) Int. Cl. C03C 21/00; C03C 15/00; C03C 23/00; C03C 27/10

(52) U.S. Cl. CPC C03C 21/005; C03C 15/00; C03C 23/002; C03C 27/10; C03C 2203/50; C03C 2204/08

(57) ABSTRACT

The present invention relates to a glass article with improved surface quality and to a method of making a glass article.

### CROSS-REFERENCE TO RELATED APPLICATIONS

This application is a national stage entry under 35 U.S.C. § 371 of International Patent Application No. PCT/CN2021/135314 entitled “GLASS ARTICLE WITH IMPROVED SURFACE QUALITY,” filed on Dec. 3, 2021, which is incorporated in its entirety herein by reference.

### BACKGROUND OF THE INVENTION

### 1. Technical Field of the Invention

The present invention relates to a glass article with improved surface quality and to a method of making a glass article.

### 2. Description of the Related Art

Ultrathin glass (UTG) has large potential in various applications such as consumer electronics and optics. In particular in view of its flexibility UTG is advantageous for flexible displays, for example in smartphones.

Producing UTG in various ultrathin target thicknesses is technically difficult. A common approach is to produce a glass article in a larger thickness, in particular by a down draw or overflow fusion process, and then introduce a slimming process to reach the target thickness.

Due to its small thickness and its brittleness, the most commonly applied processing method is stack processing. In stack processing a stack assembly is formed, the stack assembly comprising a plurality of glass articles and at least one adhesive layer between two adjacent glass articles. Such a stack assembly is then processed in several stack processing steps such as cutting to the desired article size, grinding the edges, and/or an etching step for obtaining a chamfer structure at the edges.

However, the slimming process for reaching the target thickness mentioned above is applied after delamination of the stack assembly. The reason is that the etching solution applied for slimming has to get in contact with the main surfaces of the glass article in order for slimming to occur. The main surfaces of a glass article are protected from the etching solution by the adhesive layers connecting the article to the adjacent articles in the stack assembly. Thus, the stack assembly is first delaminated by removing the adhesive layers, and subsequently the individualized glass articles are subjected to the slimming process in the etching solution in order to obtain the desired UTG articles.

A draw-back of the slimming process is that it results in an impaired surface quality as compared to the pristine surface quality of the glass articles obtained by down draw. The down draw method results in glass articles in which both of its main surfaces are fire-polished. Fire-polished surfaces are characterized by a particularly low surface roughness. Furthermore, fire-polished surfaces are advantageous due to the low number of surface flaws. The surface quality of fire-polished surface is extraordinarily good. A good surface quality is particularly advantageous for the bending properties. Surface flaws may result in a substantial reduction of bending strength. This is particularly the case for surface flaws on the glass surface at the outer side of the bend that is subjected to tensile stresses during bending.

There is a need for UTG having improved bending strength.

Furthermore, the UTG should fulfill other criteria as well in addition to its bendability. In particular, the UTG should withstand mechanical impacts generally occurring during its use, for example in electronic devices such as smartphones. A high impact resistance is advantageous.

Interestingly, in particular in bendable electronic devices such as smartphones, the requirements on UTG are often asymmetric as to the two main surfaces thereof. For example, the devices are generally arranged such that they are foldable in a way that the surface of the UTG facing the user represents the inner side of the bend. Thus, this UTG surface faces particularly high demands on its impact resistance as it is directly exposed to external impacts of various kinds. The opposite UTG surface on the other hand represents the outer side of the bend so that it faces particularly high demands on its bending strength due to the tensile stresses induced by bending.

Thus, there is a need for UTG combining a first surface with particularly high impact resistance and a second surface with particularly high bending strength.

A commonly used approach to further increase the strength of UTG is the introduction of chamfer structure at the edge thereof. This is generally done during stack processing of glass articles using an etchant solution. As the etchant solution has access to the edges of the article in a symmetrical way, this results in symmetric chamfer structures that are not optimized with respect to asymmetric strength requirements described above.

It is therefore an object of the present invention to overcome the problems of the prior art. In particular, it is an object of the invention to provide an asymmetric UTG optimized for the asymmetric requirements on impact resistance and bendability such as in applications in smartphones and other electronic devices. It is also an object of the invention to provide a method for producing such an UTG.

### SUMMARY OF THE INVENTION

The present invention includes the idea of protecting the second surface of the glass article not only during chamfer etching but also during the subsequent etching step that is done for slimming the glass article to the desired thickness. This is advantageous in several ways. The low surface roughness of the second surface can be maintained. Protecting the second surface of the glass article (but not the first surface of the glass article) during slimming results in an asymmetrification of the chamfer structure reflecting the asymmetric needs implied by the use of UTG in foldable electronic devices such as smartphones. The high surface quality of the second surface makes it ideal for forming the outer surface of the bend and withstanding the tensile stresses occurring thereupon. In particular, the second surface can be provided with high ball-on-ring failure force and high 2-point bending strength.

On the other hand, the first surface of the UTG is very well suited for facing the user of the electronic device as the first surface has a high impact resistance, in particular upon chemically strengthening the UTG. This is surprising. Without wishing to be bound by a certain theory, the high impact resistance of the first surface may, at least partially, be explained based on its comparably high density. The first surface corresponds to a region of the glass article that was located in the interior of the article prior to the slimming process. Therefore, it experienced slower cooling rates during production resulting in a higher density. A higher density in turn is associated with higher achievable CS values upon chemical toughening.

The glass article of the present invention is very well suitable for being used in foldable electronic devices, in particular in such foldable electronic devices, in which the first surface of the glass article requires high impact resistance as it is facing the exterior of the device, and in which the second surface of the glass article requires high bending strength due to it being at the outer surface of the bend so that it experiences tensile stresses.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 schematically shows the profile of a glass article comprising a first surface, a second surface and at least one edge connecting the first surface and the second surface;

FIG. 2 schematically shows the profile of a glass article comprising a first surface, a second surface and at least one edge connecting the first surface and the second surface;

FIG. 3 shows a cross-sectional microscope image of a glass article having an asymmetric chamfer structure;

FIG. 4A shows a top/bottom view of a schematic representation of the set-up of the ball-on-ring test not drawn to scale; and

FIG. 4B shows a cross-sectional view of the set-up.

### DETAILED DESCRIPTION OF THE INVENTION

In a first aspect, the present invention relates to a glass article having a thickness of from 10 μm to 150 μm, the glass article comprising
a first surface, a second surface and at least one edge connecting the first surface and the second surface, and,
wherein the surface roughness Rₐ (arithmetic average roughness) of the second surface is at most 0.30 nm.

In a second aspect, the present invention relates to a glass article having a thickness of from 10 μm to 150 μm, the glass article comprising
a first surface, a second surface and at least one edge connecting the first surface and the second surface,
wherein the first surface and the second surface are essentially parallel to each other,
wherein the edge has a chamfer structure comprising three surfaces,
   a perpendicular surface being essentially perpendicular to the first surface and to the second surface,
   a primary connecting surface connecting the perpendicular surface and the first surface, and
   a secondary connecting surface connecting the perpendicular surface and the second surface,
wherein the chamfer structure has a profile such that
   a tangent line A to the primary connecting surface crosses a tangent line B to the first surface at a distance d₁ from a tangent line C to the perpendicular surface, and
   a tangent line D to the secondary connecting surface crosses a tangent line E to the second surface at a distance d₂ from the tangent line C to the perpendicular surface,
   wherein both d₁ and d₂ are measured perpendicular to the tangent line C to the perpendicular surface,
   wherein tangent lines A to E are obtained by fitting a respective tangent line to the corresponding surface in the profile of the chamfer structure,
wherein the chamfer structure is asymmetric such that d₁≠d₂.

In a third aspect, the present invention relates to a glass article having a thickness of from 10 μm to 150 μm, the glass article comprising.
a first surface, a second surface and at least one edge connecting the first surface and the second surface,
wherein the first surface has an impact resistance corresponding to a pen drop height of at least 5 mm, and
wherein the second surface has a ball-on-ring failure force of at least 5.0 N and/or a 2-point bending strength of at least 2,000 MPa.

In a fourth aspect, the present invention relates to a method of processing a glass article having a first surface and a second surface, in particular a method of producing a glass article of the invention, the method comprising the following steps:
a) Providing a glass article
b) Forming a stack assembly comprising a plurality of glass articles and at least one adhesive layer between two adjacent glass articles, wherein the first surface of the glass article is in contact with a first adhesive layer comprising a first adhesive and the second surface of the glass article is in contact with a second adhesive layer comprising a second adhesive,
c) Contacting the stack assembly with a first etching solution,
d) Delaminating the stack assembly by removing the first adhesive layer, wherein sandwich assemblies are obtained consisting of two glass articles and the second adhesive layer located between the two glass articles,
e) Contacting the sandwich assemblies with a second etching solution,
f) Delaminating the sandwich assemblies by removing the second adhesive layer.

The present invention also relates to a method of processing a plurality of glass articles having a first surface and a second surface, in particular a method of producing a glass article according to at least one of the preceding claims, the method comprising the following steps:
a) Providing a plurality of glass articles,
b) Forming a stack assembly comprising the plurality of glass articles and at least one adhesive layer between two adjacent glass articles, wherein the first surface of the glass articles is in contact with a first type of adhesive and the second surface of the glass articles is in contact with a second type of adhesive,
c) Contacting the stack assembly or smaller stack assemblies obtained therefrom with a first etching solution,
d) Delaminating the stack assembly or the smaller stack assemblies obtained therefrom by removing the first type of adhesive, wherein sandwich assemblies are obtained consisting of two glass articles and the second type of adhesive located between the two glass articles,
e) Contacting the sandwich assemblies with a second etching solution,
f) Delaminating the sandwich assemblies by removing the second type of adhesive.

The present invention also relates to a bendable device comprising the glass article of the invention.

The present invention relates to a glass article having a thickness of from 10 μm to 150 μm, the glass article comprising a first surface, a second surface and at least one edge connecting the first surface and the second surface, wherein the article is characterized by
A) The surface roughness Rₐ (arithmetic average roughness) of the second surface being at most 0.30 nm,
B) The first surface and the second surface being essentially parallel to each other,
   wherein the edge has a chamfer structure comprising three surfaces,
      a perpendicular surface being essentially perpendicular to the first surface and to the second surface,
      a primary connecting surface connecting the perpendicular surface and the first surface, and
      a secondary connecting surface connecting the perpendicular surface and the second surface,
   wherein the chamfer structure has a profile such that
      a tangent line A to the primary connecting surface crosses a tangent line B to the first surface at a distance d₁ from a tangent line C to the perpendicular surface, and
      a tangent line D to the secondary connecting surface crosses a tangent line E to the second surface at a distance d₂ from the tangent line C to the perpendicular surface,
      wherein both d₁ and d₂ are measured perpendicular to the tangent line C to the perpendicular surface,
      wherein tangent lines A to E are obtained by fitting a respective tangent line to the corresponding surface in the profile of the chamfer structure,
   wherein the chamfer structure is asymmetric such that d₁≠d₂, and/or
C) The first surface having an impact resistance corresponding to a pen drop height of at least 5 mm, and the second surface having a ball-on-ring failure force of at least 5.0 N and/or a 2-point bending strength of at least 2,000 MPa.

In some embodiments, the present invention relates to a glass article having a thickness of from 10 μm to 150 μm, the glass article comprising a first surface, a second surface and at least one edge connecting the first surface and the second surface, wherein the article is characterized by
A) The surface roughness Rₐ (arithmetic average roughness) of the second surface being at most 0.30 nm, and
B) The first surface and the second surface being essentially parallel to each other,
   wherein the edge has a chamfer structure comprising three surfaces,
      a perpendicular surface being essentially perpendicular to the first surface and to the second surface,
      a primary connecting surface connecting the perpendicular surface and the first surface, and
      a secondary connecting surface connecting the perpendicular surface and the second surface,
   wherein the chamfer structure has a profile such that
      a tangent line A to the primary connecting surface crosses a tangent line B to the first surface at a distance d₁ from a tangent line C to the perpendicular surface, and
      a tangent line D to the secondary connecting surface crosses a tangent line E to the second surface at a distance d₂ from the tangent line C to the perpendicular surface,
      wherein both d₁ and d₂ are measured perpendicular to the tangent line C to the perpendicular surface,
      wherein tangent lines A to E are obtained by fitting a respective tangent line to the corresponding surface in the profile of the chamfer structure,
   wherein the chamfer structure is asymmetric such that d₁≠d₂.

In some embodiments, the present invention relates to a glass article having a thickness of from 10 μm to 150 μm, the glass article comprising a first surface, a second surface and at least one edge connecting the first surface and the second surface, wherein the article is characterized by
A) The surface roughness Rₐ (arithmetic average roughness) of the second surface being at most 0.30 nm, and
B) The first surface having an impact resistance corresponding to a pen drop height of at least 5 mm, and the second surface having a ball-on-ring failure force of at least 5.0 N and/or a 2-point bending strength of at least 2,000 MPa.

In some embodiments, the present invention relates to a glass article having a thickness of from 10 μm to 150 μm, the glass article comprising a first surface, a second surface and at least one edge connecting the first surface and the second surface, wherein the article is characterized by
A) The first surface and the second surface being essentially parallel to each other,
   wherein the edge has a chamfer structure comprising three surfaces,
      a perpendicular surface being essentially perpendicular to the first surface and to the second surface,
      a primary connecting surface connecting the perpendicular surface and the first surface, and
      a secondary connecting surface connecting the perpendicular surface and the second surface,
   wherein the chamfer structure has a profile such that
      a tangent line A to the primary connecting surface crosses a tangent line B to the first surface at a distance d₁ from a tangent line C to the perpendicular surface, and
      a tangent line D to the secondary connecting surface crosses a tangent line E to the second surface at a distance d₂ from the tangent line C to the perpendicular surface,
      wherein both d₁ and d₂ are measured perpendicular to the tangent line C to the perpendicular surface,
      wherein tangent lines A to E are obtained by fitting a respective tangent line to the corresponding surface in the profile of the chamfer structure,
   wherein the chamfer structure is asymmetric such that d₁≠d₂, and
B) The first surface having an impact resistance corresponding to a pen drop height of at least 5 mm, and the second surface having a ball-on-ring failure force of at least 5.0 N and/or a 2-point bending strength of at least 2,000 MPa.

In some embodiments, the present invention relates to a glass article having a thickness of from 10 μm to 150 μm, the glass article comprising a first surface, a second surface and at least one edge connecting the first surface and the second surface, wherein the article is characterized by
A) The surface roughness Rₐ (arithmetic average roughness) of the second surface being at most 0.30 nm,
B) The first surface and the second surface being essentially parallel to each other,
   wherein the edge has a chamfer structure comprising three surfaces,
      a perpendicular surface being essentially perpendicular to the first surface and to the second surface,
      a primary connecting surface connecting the perpendicular surface and the first surface, and
      a secondary connecting surface connecting the perpendicular surface and the second surface,
   wherein the chamfer structure has a profile such that
      a tangent line A to the primary connecting surface crosses a tangent line B to the first surface at a distance d₁ from a tangent line C to the perpendicular surface, and
      a tangent line D to the secondary connecting surface crosses a tangent line E to the second surface at a distance d₂ from the tangent line C to the perpendicular surface,
      wherein both d₁ and d₂ are measured perpendicular to the tangent line C to the perpendicular surface,
      wherein tangent lines A to E are obtained by fitting a respective tangent line to the corresponding surface in the profile of the chamfer structure,
   wherein the chamfer structure is asymmetric such that d₁≠d₂, and
C) The first surface having an impact resistance corresponding to a pen drop height of at least 5 mm, and the second surface having a ball-on-ring failure force of at least 5.0 N and/or a 2-point bending strength of at least 2,000 MPa.

The glass article of the invention may for example be a sheet or sheet-like article, in particular a round-shaped article, or an article of rectangular or squared shape having a length and a width. Both length and width of the glass article are preferably much larger as compared to the thickness of the article. For example, length and/or width may be at least 1 mm, at least 2 mm, at least 5 mm, at least 10 mm, at least 15 mm, at least 20 mm, at least 25 mm, at least 30 mm, at least 40 mm, or at least 50 mm. For example, length and/or width may be at most 500 mm, at most 400 mm, at most 300 mm, at most 200 mm, at most 150 mm, at most 125 mm, at most 100 mm, or at most 70 mm. The ratio of length and width may be 1:1 or more. In some embodiments, the glass article may have a notch, in particular for the front camera in smartphone applications, and/or holes or recesses for cameras and/or microphones or speakers.

In one aspect of the present invention, the glass article may have a length in a range of from 10 mm to 500 mm and/or a width in a range of from 5 mm to 400 mm, for example a length and/or a width in a range of from 10 to 400 mm, from 15 to 300 mm, from 20 to 200 mm, from 25 to 150 mm, from 30 to 125 mm, from 40 to 100 mm, or from 50 to 70 mm. The length and/or the width may for example be at least 5 mm, at least 10 mm, at least 15 mm, at least 20 mm, at least 25 mm, at least 30 mm, at least 40 mm, or at least 50 mm. The length and/or the width may for example be at most 500 mm, at most 400 mm, at most 300 mm, at most 200 mm, at most 150 mm, at most 125 mm, at most 100 mm, or at most 70 mm.

Preferably, the article has exactly one edge connecting first and second surface thereof. Depending on the shape of the article, the edge may have different sides. For example, in case of a sheet or sheet-like article having rectangular or squared shape, the edge has four sides, wherein two opposite sides represent the length of the article and the remaining two opposite sides represent the width of the article. The positions connecting two adjacent sides of the edge are generally referred to as corners.

The glass article of the invention has a thickness of from 10 μm to 150 μm, for example from 15 μm to 120 μm, from 20 μm to 100 μm, from 25 μm to 90 μm, from 30 μm to 80 μm, from 35 μm to 70 μm, from 40 μm to 60 μm, or from 45 μm to 50 μm. The thickness of the glass article may for example be at least 10 μm, at least 15 μm, at least 20 μm, at least 25 μm, at least 30 μm, at least 35 μm, at least 40 μm, or at least 45 μm. The thickness of the glass article may for example be at most 150 μm, at most 120 μm, at most 100 μm, at most 90 μm, at most 80 μm, at most 70 μm, at most 60 μm, or at most 50 μm.

Average roughness (Rₐ) is a measure of the texture of a surface. It is quantified by the vertical deviations of a real surface from its ideal form. Commonly amplitude parameters characterize the surface based on the vertical deviations of the roughness profile from the mean line. Rₐ is the arithmetic average of the absolute values of these vertical deviations. It can be determined according to DIN EN ISO 4287:2010-07.

Surface roughness Rₐ is preferably determined with atomic force microscopy (AFM), in particular using BRUKER's Dimension Icon model. The tested area is preferably 2×2 μm² or more, or 10×10 μm² or more.

Preferably, the surface roughness Rₐ of the second surface is at most 0.30 nm, more preferably at most 0.25 nm, more preferably at most 0.20 nm, more preferably at most 0.15 nm, in particular for a 2×2 μm² or 10×10 μm² area. The surface roughness Rₐ of the second surface may for example be at least 0.05 nm, at least 0.08 nm, at least 0.10 nm, or at least 0.12 nm, in particular for a 2×2 μm² or 10×10 μm² area. The surface roughness Rₐ of the second surface may for example be in a range of from 0.05 to 0.30 nm, from 0.08 to 0.25 nm, from 0.10 to 0.20 nm, or from 0.12 to 0.15 nm, in particular for a 2×2 μm² or 10×10 μm² area.

The surface roughness Rₐ of the first surface may for example be at most 0.80 nm, at most 0.70 nm, at most 0.60 nm, at most 0.50 nm, at most 0.40 nm, at most 0.30 nm, or at most 0.20 nm, in particular for a 2×2 μm² or 10×10 μm² area. The surface roughness Rₐ of the first surface may for example be at least 0.10 nm, at least 0.11 nm, at least 0.12 nm, at least 0.13 nm, at least 0.14 nm, at least 0.15 nm, or at least 0.16 nm, in particular for a 2×2 μm² or 10×10 μm² area. The surface roughness Rₐ of the first surface may for example be in a range of from 0.10 to 0.80 nm, from 0.11 to 0.70 nm, from 0.12 to 0.60 nm, from 0.13 to 0.50 nm, from 0.14 to 0.40 nm, from 0.15 to 0.30 nm, or from 0.16 to 0.20 nm, in particular for a 2×2 μm² or 10×10 μm² area.

The surface roughness Rₐ of the first surface may be higher than the surface roughness Rₐ of the second surface. For example, the absolute value of the difference of the surface roughness Rₐ of the first surface and the surface roughness Rₐ of the second surface may be at least 0.05 nm, at least 0.10 nm, at least 0.15 nm, or at least 0.20 nm, in particular for a 2×2 μm² or 10×10 μm² area of the first surface and of the second surface. The absolute value of the difference of the surface roughness Rₐ of the first surface and the surface roughness Rₐ of the second surface may for example be at most 0.50 nm, at most 0.40 nm, at most 0.30 nm, or at most 0.25 nm, in particular for a 2×2 μm² or 10×10 μm² area of the first surface and of the second surface. The absolute value of the difference of the surface roughness Rₐ of the first surface and the surface roughness Rₐ of the second surface may for example be in a range of from 0.05 to 0.50 nm, from 0.10 to 0.40 nm, from 0.15 to 0.30 nm, or from 0.20 to 0.25 nm, in particular for a 2×2 μm² or 10×10 μm² area of the first surface and of the second surface.

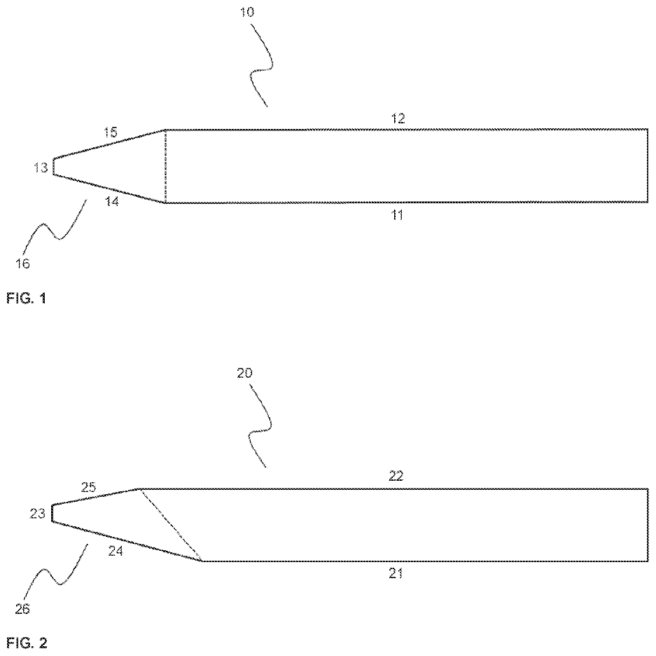

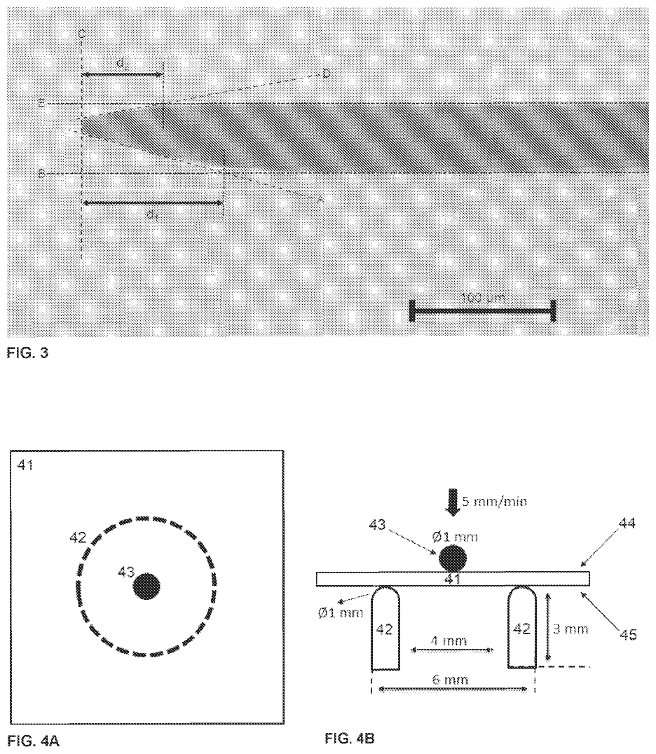

As described above, the glass article of the invention may also be characterized by an asymmetric chamfer structure. A cross-sectional profile of a glass article having an asymmetric chamfer structure is schematically shown in FIG. 2. The asymmetry may be observed and described best based on an image of a cross-section of a profile of a chamfer structure as shown in FIG. 3. In order to obtain such images, the glass article is observed with an optical microscope in transmitted light mode. A 200× magnification is used. The focus is on the top plane so that the edges look very sharp. The glass article is positioned such that the top plane is not tilted. Thus, the top plane is perpendicular to the direction of light. Images of particularly good quality are generally obtained with automatic white balance, automatic brightness and automatic contrast, in particular using Nikon Y-TV55 microscope.

As shown in FIG. 3, the asymmetry of the chamfer structure can easily be described by fitting tangent lines to the relevant surfaces in the microscope image (tangent line A to the primary connecting surface, tangent line B to the first surface, tangent line C to the perpendicular surface, tangent line D to the secondary connecting surface, and tangent line E to the second surface).

Fitting the tangent lines to respective surfaces may be done by hand using any suitable image processing software, for example ImageJ, PowerPoint, Photoshop, or the like. It will be appreciated that the skilled person is well aware of further suitable software programs. Fitting the lines is easily done by hand. A sufficiently accurate fit is obtained without major effort. However, if desired, fitting may be utilizing for example the method of least squares in order to obtain the best fit, in particular by further software support.

Notably, as also shown in FIG. 3, the transition of one surface into the other cannot always be appointed to one specific point. In particular, the secondary connecting surface, and even more pronounced the primary connecting surface may deviate from a straight line towards the transition into the second surface or into the first surface, respectively. However, this deviation relates to a minor fraction of the primary and secondary connecting surfaces only. Thus, in order to obtain a tangent line to the primary connecting surface, wherein the tangent line deviates from the primary connecting surface as little as possible, the tangent line is fitted such that the best fit is obtained towards the transition of the primary connecting surface to the perpendicular surface whereas larger deviations may be acceptable towards the transition of the primary connecting surface to the first surface. The same holds true analogously for fitting the tangent line to the secondary connecting surface.

As shown in FIG. 3, the tangent line A to the primary connecting surface crosses the tangent line B to the first surface at a distance d₁ from the tangent line C to the perpendicular surface. Likewise, the tangent line D to the secondary connecting surface crosses the tangent line E to the second surface at a distance d₂ from the tangent line C to the perpendicular surface. Both d₁ and d₂ are measured perpendicular to the tangent line C to the perpendicular surface. The length of distances d₁ and d₂ may in particular be measured using any suitable image processing software, for example ImageJ, PowerPoint, Photoshop, or the like. The measurement may include comparing the lengths of distances d₁ and d₂, respectively, with the length of the scale bar.

In an asymmetric chamfer structure, d₁ is not equal to d₂. In particular, d₁ may be larger than d₂.

The absolute value of the difference d₁−d₂ may for example be at least 30%, at least 40%, at least 50%, at least 60%, at least 70%, at least 80%, or at least 90% of the thickness of the glass article. The absolute value of the difference d₁−d₂ may for example be at most 200%, at most 180%, at most 160%, at most 140%, at most 120%, at most 110%, or at most 100% of the thickness of the glass article. The absolute value of the difference d₁−d₂ may for example be in a range of from 30% to 200%, from 40% to 180%, from 50% to 160%, from 60% to 140%, from 70% to 120%, from 80% to 110%, or from 90% to 100% of the thickness of the glass article.

The absolute value of the difference d₁−d₂ may for example be at least 15 μm, at least 20 μm, at least 25 μm, at least 30 μm, at least 35 μm, or at least 40 μm. The absolute value of the difference d₁−d₂ may for example be at most 100 μm, at most 90 μm, at most 80 μm, at most 70 μm, at most 60 μm, or at most 50 μm. The absolute value of the difference d₁−d₂ may for example be in a range of from 15 to 100 μm, from 20 to 90 μm, from 25 to 80 μm, from 30 to 70 μm, from 35 to 60 μm, or from 40 to 50 μm.

The distance d₁ may for example be at least 50 μm, at least 60 μm, at least 70 μm, at least 80 μm, or at least 90 μm. The distance d₁ may for example be at most 200 μm, at most 175 μm, at most 150 μm, at most 125 μm, or at most 100 μm. The distance d₁ may for example be in a range of from 50 to 200 μm, from 60 to 175 μm, from 70 to 150 μm, from 80 to 125 μm, or from 90 to 100 μm.

The distance d₂ may for example be at least 30 μm, at least 35 μm, at least 40 μm, at least 45 μm, or at least 50 μm. The distance d₂ may for example be at most 100 μm, at most 90 μm, at most 80 μm, at most 70 μm, or at most 60 μm. The distance d₂ may for example be in a range of from 30 to 100 μm, from 35 to 90 μm, from 40 to 80 μm, from 45 to 70 μm, or from 50 to 60 μm.

The present invention relates to glass article being asymmetric with respect to the surface roughness of the first and second surface, with respect to the chamfer structure, and/or with respect to the impact and bending properties of the first and second surface. In particular, the glass articles of the invention may have a first surface that has a very good impact resistance and a second surface having a very good bending strength. This is particularly advantageous for a use of the glass article in bendable electronic devices such as smart phones, wherein the first surface faces various external impacts and the second surface represent the outer surface of the glass article in a bent state.

A measure for impact resistance is the pen drop height. The higher the pen drop height, the higher the impact resistance. The pen drop height is a breakage height that is determined in a pen drop test in which the glass article is attached with one surface to a 150 μm thick substrate, which consists of, from the side contacting the glass to the side contacting the marble stage, a 25 μm thick layer of pressure sensitive adhesive (PSA) material, a 50 μm thick layer of polyethylene (PE), another 25 μm thick layer of pressure sensitive adhesive (PSA), and another 50 μm thick layer of polyethylene (PE). Beneath the 150 μm thick substrate, there is a flat 10 cm thick marble stage, with polished smooth surface. The other surface of the glass article facing upwards (i.e. the surface whose pen drop height is actually tested) is then subsequently impacted with a 14 g ball point pen (Made by Chenguang) with the 0.5 mm diameter ball made from tungsten carbide, with increasing height from 5 mm until the glass breaks. The failure height is then recorded as the pen drop height.

The first surface of the glass article may have an impact resistance corresponding to a pen drop height of at least 5 mm, at least 10 mm, at least 15 mm, at least 20 mm, at least 25 mm, at least 30 mm, at least 35 mm, at least 40 mm, at least 45 mm, at least 50 mm, at least 75 mm, at least 100 mm, at least 150 mm, at least 200 mm, at least 300 mm, at least 400 mm, or at least 500 mm. The first surface of the glass article may have an impact resistance corresponding to a pen drop height of at most 10,000 mm, at most 5,000 mm, at most 4,000 mm, at most 3,000 mm, at most 2,000 mm, at most 1,500 mm, or at most 1,000 mm. In some embodiments, the first surface of the glass article may have an impact resistance corresponding to a pen drop height of at most 500 mm, at most 450 mm, at most 400 mm, at most 350 mm, at most 300 mm, at most 250 mm, at most 200 mm, at most 150 mm, at most 100, or at most 75 mm. The first surface of the glass article may have an impact resistance corresponding to a pen drop height in a range of from 5 to 500 mm, from 10 to 450 mm, from 15 to 400 mm, from 20 to 350 mm, from 25 to 300 mm, from 30 to 250 mm, from 35 to 200 mm, from 40 to 150 mm, from 45 to 100 mm, or from 50 to 75 mm. In other embodiments, the first surface of the glass article may have an impact resistance corresponding to a pen drop height in a range of from 75 to 10,000 mm, from 100 to 5,000 mm, from 150 to 4,000 mm, from 200 to 3,000 mm, from 300 to 2,000 mm, from 400 to 1,500 mm, or from 500 to 1,000 mm.

It is also possible to normalize the pen drop height to the thickness of the glass article. A normalized pen drop height may be obtained as the ratio of the pen drop height (in μm) and the square of the article thickness (in μm²). For example, if a certain glass article has a pen drop height of 10 mm (=10,000 μm) and the thickness of the article is 50 μm, the normalized pen drop height can be obtained as 10,000 μm divided by 50² μm², resulting in a value of 4.0 per μm for the normalized pen drop height.

The first surface of the glass article may have an impact resistance corresponding to a normalized pen drop height of at least 4.5 per μm, at least 5.0 per μm, at least 5.5 per μm, at least 6.0 per μm, at least 6.5 per μm, at least 7.0 per μm, at least 7.5 per μm, at least 8.0 per μm, at least 8.5 per μm, at least 9.0 per μm, at least 9.5 per μm, at least 10.0 per μm, or at least 10.5 per μm. The first surface of the glass article may have an impact resistance corresponding to a normalized pen drop height of at most 60.0 per μm, at most 50.0 per μm, at most 45.0 per μm, at most 40.0 per μm, at most 35.0 per μm, at most 30.0 per μm, at most 25.0 per μm, at most 20.0 per μm, at most 18.0 per μm, at most 16.0 per μm, at most 14.0 per μm, at most 12.0 per μm, or at most 11.0 per μm. The first surface of the glass article may have an impact resistance corresponding to a normalized pen drop height in a range of from 4.5 to 60.0 per μm, from 5.0 to 50.0 per μm, from 5.5 to 45.0 per μm, from 6.0 to 40.0 per μm, from 6.5 to 35.0 per μm, from 7.0 to 30.0 per μm, from 7.5 to 25.0 per μm, from 8.0 to 20.0 per μm, from 8.5 to 18.0 per μm, from 9.0 to 16.0 per μm, from 9.5 to 14.0 per μm, from 10.0 to 12.0 per μm, or from 10.5 to 11.0 per μm.

The second surface of the glass article may have an impact resistance corresponding to a normalized pen drop height of at least 2.0 per μm, at least 2.5 per μm, at least 3.0 per μm, at least 3.5 per μm, at least 4.0 per μm, at least 4.5 per μm, at least 5.0 per μm, at least 5.5 per μm, at least 6.0 per μm, at least 6.5 per μm, at least 7.0 per μm, at least 7.5 per μm, or at least 8.0 per μm. The second surface of the glass article may have an impact resistance corresponding to a normalized pen drop height of at most 50.0 per μm, at most 45.0 per μm, at most 40.0 per μm, at most 35.0 per μm, at most 30.0 per μm, at most 25.0 per μm, at most 20.0 per μm, at most 18.0 per μm, at most 16.0 per μm, at most 14.0 per μm, at most 12.0 per μm, at most 10.0 per μm, or at most 9.0 per μm. The second surface of the glass article may have an impact resistance corresponding to a normalized pen drop height in a range of from 2.0 to 50.0 per μm, from 2.5 to 45.0 per μm, from 3.0 to 40.0 per μm, from 3.5 to 35.0 per μm, from 4.0 to 30.0 per μm, from 4.5 to 25.0 per μm, from 5.0 to 20.0 per μm, from 5.5 to 18.0 per μm, from 6.0 to 16.0 per μm, from 6.5 to 14.0 per μm, from 7.0 to 12.0 per μm, from 7.5 to 10.0 per μm, or from 8.0 to 9.0 per μm.

As described above, the pen drop height of the first surface of the glass article is particularly high. In particular, the pen drop height of the first surface of the glass article may be higher as compared to the pen drop height of the second surface of the glass article. The ratio of the pen drop height of the first surface and the pen drop height of the second surface may for example be at least 1.05, at least 1.10, at least 1.15, at least 1.20, at least 1.25, at least 1.30, at least 1.35, or at least 1.40. The ratio of the pen drop height of the first surface and the pen drop height of the second surface may for example be at most 2.50, at most 2.25, at most 2.00, at most 1.90, at most 1.80, at most 1.70, at most 1.60, or at most 1.50. The ratio of the pen drop height of the first surface and the pen drop height of the second surface may for example be in a range of from 1.05 to 2.50, from 1.10 to 2.25, from 1.15 to 2.00, from 1.20 to 1.90, from 1.25 to 1.80, from 1.30 to 1.70, from 1.35 to 1.60, or from 1.40 to 1.50.

The second surface of the glass article may be particularly suitable for withstanding tensile stresses occurring on the second surface upon bending of the glass article such that the second surface represents the outer surface of the bend. This is reflected by the second surface having a particularly high ball-on-ring failure force and/or 2-point bending strength. In particular, the ball-on-ring failure force and/or the 2-bending strength of the second surface of the glass article may be higher as compared to the ball-on-ring failure force and/or the 2-bending strength of the first surface, respectively.

As schematically illustrated in FIG. 4, the ball-on-ring failure force may be tested by placing surface 45 of the glass article 41 on a steel ring 42, the ring 42 having an inner diameter of 4 mm and an outer diameter of 6 mm. The ring 42 is 3 mm deep, and the wall of the ring 42 is 1 mm thick with the tip of the wall having a semi-circle with a diameter of 1 mm as cross-section. For testing the ball-on-ring failure force, the edges of the glass article 41 are at least 20 mm away from the center of the ring 42. A tungsten carbide ball 43 having a diameter of 1 mm is pressed against the surface 44 of glass article 41 along the center axis of the ring 42, with a speed of 5 mm/min until the glass shutters. The force at failure is recorded as the ball-on-ring failure force.

Depending on which of the surfaces of the glass article 41 is contacted with the ring 42 or with the ball 43, respectively, the ball-on-ring failure force of the first surface or of the second surface of glass article 41 can be tested. The ball-on-ring test as described herein is adjusted for determining the ball-on-ring failure force of that particular surface of the glass article 41 that is in contact with the steel ring 42. For example, if the second surface of the glass article 41 is surface 45 being contacted with the steel ring 42 whereas the first surface of the glass article 41 is surface 44 being contacted with the ball 43, the output of the ball-on-ring test is the ball-on-ring failure force of the second surface. However, if the first surface of the glass article 41 is surface 45 being contacted with the steel ring 42 whereas the second surface of the glass article 41 is surface 44 being contacted with the ball 43, the output of the ball-on-ring test is the ball-on-ring failure force of the first surface. It is surface 45 of the glass article 41 that experiences tensile forces during the ball-on-ring test. Therefore, the output of the ball-on-ring test is the ball-on-ring failure force of surface 45.

The second surface of the glass article may have a ball-on-ring failure force of at least 5.0 N, at least 7.5 N, at least 10.0 N, at least 12.5 N, at least 15.0 N, or at least 17.5 N. The second surface of the glass article may have a ball-on-ring failure force of at most 50.0 N, at most 40.0 N, at most 30.0 N, at most 25.0 N, at most 22.5 N, or at most 20.0 N. The second surface of the glass article may have a ball-on-ring failure force in a range of from 5.0 to 50.0 N, from 7.5 to 40.0 N, from 10.0 to 30.0 N, from 12.5 to 25.0 N, from 15.0 to 22.5 N, or from 17.5 to 20.0 N.

The first surface of the glass article may have a ball-on-ring failure force of at least 1.0 N, at least 2.0 N, at least 5.0 N, at least 7.5 N, at least 10.0 N, or at least 12.5 N. The second surface of the glass article may have a ball-on-ring failure force of at most 30.0 N, at most 25.0 N, at most 22.5 N, at most 20.0 N, at most 17.5 N, or at most 15.0 N. The second surface of the glass article may have a ball-on-ring failure force in a range of from 1.0 to 30.0 N, from 2.0 to 25.0 N, from 5.0 to 22.5 N, from 7.5 to 20.0 N, from 10.0 to 17.5 N, or from 12.5 to 15.0 N.

As described above, the ball-on-ring failure force of the second surface of the glass article is particularly high. In particular, the ball-on-ring failure force of the second surface of the glass article may be higher as compared to the ball-on-ring failure force of the first surface of the glass article. The ratio of the ball-on-ring failure force of the second surface and the ball-on-ring failure force of the first surface may for example be at least 1.05, at least 1.10, at least 1.15, at least 1.20, or at least 1.25. The ratio of the ball-on-ring failure force of the second surface and the ball-on-ring failure force of the first surface may for example be at most 2.00, at most 1.75, at most 1.50, at most 1.40, or at most 1.30. The ratio of the ball-on-ring failure force of the second surface and the ball-on-ring failure force of the first surface may for example be in a range of from 1.05 to 2.00, from 1.10 to 1.75, from 1.15 to 1.50, from 1.20 to 1.40, or from 1.25 to 1.30.

The particular good bendability of the glass article of the invention is also reflected by the 2-point bending strength (2PB strength) of the second surface being particular high. For testing the 2PB strength, the glass article is placed as a U-shape between two parallel metal plates. The two plates are big enough to cover the whole glass article. Then one of the plate moves towards the other one while remaining parallel with a speed of 60 mm/min until the glass article breaks. The 2PB strength is calculated by:

σ=1.198Ed/(D−d)

where σ is the calculated 2PB strength; E is the Young's modulus of the glass; d is the thickness of the glass article; D is the distance between the two plates at failure.

The output of the 2PB test is the 2PB strength of the surface of the glass article that represented the outer surface of the bend. For example, if the glass article was bent such that the second surface of the glass article was the outer surface of the bend whereas the first surface of the glass article was the inner surface of the bend, the output of the 2PB test is the 2PB strength of second surface of the glass article.

The second surface of the glass article may for example have a 2PB strength of at least 1500 MPa, at least 1750 MPa, at least 2000 MPa, at least 2250 MPa, at least 2500 MPa, at least 2750 MPa, or at least 3000 MPa. The second surface of the glass article may for example have a 2PB strength of at most 10,000 MPa, at most 7500 MPa, at most 6000 MPa, at most 5000 MPa, at most 4500 MPa, at most 4000 MPa, or at most 3500 MPa. The second surface of the glass article may for example have a 2PB strength in a range of from 1500 to 10,000 MPa, from 1750 to 7500 MPa, from 2000 to 6000 MPa, from 2250 to 5000 MPa, from 2500 to 4500 MPa, from 2750 to 4000 MPa, or from 3000 to 3500 MPa.

The first surface of the glass article may for example have a 2PB strength of at least 1000 MPa, at least 1250 MPa, at least 1500 MPa, at least 1750 MPa, at least 2000 MPa, at least 2250 MPa, or at least 2500 MPa. The first surface of the glass article may for example have a 2PB strength of at most 7500 MPa, at most 5000 MPa, at most 4500 MPa, at most 4000 MPa, at most 3500 MPa, at most 3000 MPa, or at most 2750 MPa. The first surface of the glass article may for example have a 2PB strength in a range of from 1000 to 7500 MPa, from 1250 to 5000 MPa, from 1500 to 4500 MPa, from 1750 to 4000 MPa, from 2000 to 3500 MPa, from 2250 to 3000 MPa, or from 2500 to 2750 MPa.

As described above, the 2PB strength of the second surface of the glass article is particularly high. In particular, the 2PB strength of the second surface of the glass article may be higher as compared to the 2PB strength of the first surface of the glass article. The ratio of the 2PB strength of the second surface and the 2PB strength of the first surface may for example be at least 1.05, at least 1.10, at least 1.15, at least 1.20, or at least 1.25. The ratio of the 2PB strength of the second surface and the 2PB strength of the first surface may for example be at most 2.00, at most 1.75, at most 1.50, at most 1.40, or at most 1.30. The ratio of the 2PB strength of the second surface and the 2PB strength of the first surface may for example be in a range of from 1.05 to 2.00, from 1.10 to 1.75, from 1.15 to 1.50, from 1.20 to 1.40, or from 1.25 to 1.30.

The glass article of the present invention may be chemically toughened, in particular by subjecting the article to an ion exchange treatment.

Compressive stress (CS) (also referred to as “Pressure stress” or “surface stress”) is the stress that results from the displacement effect on the glass network through the glass surface after ion exchange, while no deformation occurs in the glass.

“Penetration depth” or “depth of ion exchanged layer” or “ion exchange depth” (“depth of layer” or “depth of ion exchanged layer”, DoL) is the thickness of the glass surface layer in which ion exchange occurs and compressive stress is generated. The compressive stress CS and the penetration depth DoL can be measured optically (in particular by a waveguide mechanism), using the commercially available stress meter FSM6000 (for example company “Luceo Co., Ltd.”, Japan, Tokyo).

When CS is induced on one side or both sides of single glass sheet, to balance the stress according to the 3rd principle of Newton's law, a tension stress must be induced in the center region of glass, and it is called central tension (CT). CT can be calculated from measured CS and DoL values.

Ion exchange means that the glass is hardened or chemically tempered (also called chemically toughened) by ion exchange processes, a process that is well known to the person skilled in the art in the field of glass making and processing. The toughening process may be done by immersing the glass layer into a salt bath which contains monovalent ions to exchange with alkali ions inside the glass. The monovalent ions in the salt bath have radii larger than alkali ions inside the glass. A compressive stress to the glass is built up after ion-exchange due to larger ions squeezing into the glass network. After ion-exchange, the strength and flexibility of glass are significantly improved. In addition, the CS induced by chemical toughening improves the bending properties of the toughened glass layer and increases scratch resistance of the glass layer. The typical salt used for chemical tempering is, for example, K⁺-containing molten salt or mixtures of salts. Optional salt baths for chemical toughening are Na⁺-containing and/or K⁺-containing molten salt baths or mixtures thereof. Optional salts are NaNO₃, KNO₃, NaCl, KCl, Na₂SO₄, K₂SO₄, Na₂CO₃, K₂CO₃, and K₂Si₂O₅. Additives such as NaOH, KOH and other sodium salts or potassium salts are also used to better control the rate of ion exchange for chemical tempering. Ion exchange may for example be done in KNO₃ at temperatures in a range of from 300° C. to 480° C., in particular from 340° C. to 450° C. or from 390° C. to 450° C., for example for a time span of from 30 seconds to 48 hours, in particular for about 20 minutes. Chemical toughening is not limited to a single step. It can include multi steps in one or more salt baths with alkaline metal ions of various concentrations to reach better toughening performance. Thus, the chemically toughened glass layer can be toughened in one step or in the course of several steps, e.g. two steps. Two-step chemical toughening is in particular applied to Li₂O-containing glasses as lithium may be exchanged for both sodium and potassium ions.

The chemically toughened glass article of the invention may have a surface compressive stress CS1 at the first surface and a surface compressive stress CS2 at the second surface.

CS1 and/or CS2 may for example be at least 300 MPa, at least 350 MPa, at least 400 MPa, at least 450 MPa, at least 500 MPa, at least 550 MPa, or at least 600 MPa. CS1 and/or CS2 may for example be at most 1000 MPa, at most 900 MPa, at most 850 MPa, at most 800 MPa, at most 750 MPa, at most 700 MPa, or at most 650 MPa. CS1 and/or CS2 may for example be in a range of from 300 to 1000 MPa, from 350 to 900 MPa, from 400 to 850 MPa, from 450 to 800 MPa, from 500 to 750 MPa, from 550 to 700 MPa, or from 600 to 650 MPa.

In some embodiments, CS1 and/or CS2 may be smaller than 600 MPa, for example at most 550 MPa, at most 500 MPa, or at most 475 MPa. CS1 and/or CS2 may for example be in a range of from 300 to 600 MPa, from 350 to 550 MPa, from 400 to 500 MPa, or from 450 to 475 MPa.

The surface compressive stress CS1 at the first surface may be higher than the surface compressive stress CS2 at the second surface. The first surface corresponds to a region of the glass article that was located in the interior of the article prior to the slimming process. Therefore, it experienced slower cooling rates during production resulting in a higher density. A higher density in turn is associated with higher achievable CS values at the first surface of the glass article upon chemical toughening.

The absolute value of the difference CS1-CS2 may for example be at least 10 MPa, at least 15 MPa, at least 20 MPa, at least 30 MPa, or at least 50 MPa. The absolute value of the difference CS1-CS2 may for example be at most 100 MPa, at most 90 MPa, at most 80 MPa, at most 70 MPa, or at most 60 MPa. The absolute value of the difference CS1-CS2 may for example be in a range of from 10 to 100 MPa, from 15 to 90 MPa, from 20 to 80 MPa, from 30 to 70 MPa, or from 50 to 60 MPa.

The chemically toughened glass article of the invention may have a first compressive stress layer extending from the first surface of the glass article to a first depth of layer DoL1 and a second compressive stress layer extending from the second surface to a second depth of layer DoL2.

DoL1 and/or DoL2 may for example be at least 2.5 μm, at least 5.0 μm, at least 7.5 μm, or at least 10.0 μm. DoL1 and/or DoL2 may for example be at most 20.0 μm, at most 17.5 μm, at most 15.0 μm, or at most 12.5 μm. DoL1 and/or DoL2 may for example be in a range of from 2.5 to 20.0 μm, from 5.0 to 17.5 μm, from 7.5 to 15.0 μm, or from 10.0 to 12.5 μm.

DoL1 and/or DoL2 may be adapted to the thickness of the glass article. For example, DoL1 and/or DoL2 may be at least 5.0%, at least 7.5%, at least 10.0%, at least 12.5%, at least 15.0%, or at least 17.5% of the thickness of the glass article. DoL1 and/or DoL2 may for example be at most 40.0%, at most 35.0% at most 30.0%, at most 27.5%, at most 25.0%, or at most 22.5% of the thickness of the glass article. DoL1 and/or DoL2 may for example be in a range of from 5.0% to 40.0%, from 7.5% to 35.0%, from 10.0% to 30.0%, from 12.5% to 27.5%, from 15.0% to 25.0%, or from 17.5% to 22.5% of the thickness of the article.

DoL2 may be higher than DoL1. As described above, the first surface of the glass article experienced slower cooling rates during production resulting in a higher density. A higher density at the first surface may be associated with a lower depth of layer DoL1 of the compressive stress layer extending from the first surface towards the center of the glass article as compared to the depth of layer DoL2 of the compressive stress layer extending from the second surface of the glass article to the center thereof. The ratio DoL2/DoL1 may be higher than 1.00, for example at least 1.01, at least 1.02, at least 1.03, or at least 1.04. The ratio DoL2/DoL1 may for example be at most 1.20, at most 1.15, at most 1.10, at most 1.07, or at most 1.05. The ratio DoL2/DoL1 may for example be in a range of from >1.00 to 1.20, from 1.01 to 1.15, from 1.02 to 1.10, from 1.03 to 1.07, or from 1.04 to 1.05.

Differences of DoL1 and DoL2 may be associated with the glass article having a certain warp. In particular, the glass article may have a warp such that the first surface of the glass article is convex and the second surface of the glass article is concave. Without wishing to be bound by a certain theory, this may at least partially be explained by the higher depth of layer DoL2 of the compressive stress layer extending from the second surface towards the center of the glass article not being balanced entirely by the smaller depth of layer DoL1 of the compressive stress layer extending from the first surface towards the center of the glass article. As a result, the second surface may be “pushed” towards the center of the glass article (resulting in a concave second surface), whereas the first surface is in turn “pushed” outwards (resulting in a convex first surface). Generally, it is a fixed believe in the field that warp should be avoided. However, in the present case it turned out that a certain warp is even advantageous for the bendability of the article. Notably, as described above, the first surface of the glass article of the invention is particularly suitable for facing the user of a bendable electronic device such as a smartphone making it represent the inner surface of the bend. As also described above, it is generally the outer surface of a bend that faces particular problems due to the tensile forces. However, a problem occurring towards the inner surface of a bend are so-called folding creases. Interestingly, a convex first surface of the glass article of the invention counteracts the problem of folding creases. Thus, this makes the first surface even more suitable for being the inner surface of the bend.

The warp may for example be measured by placing the glass article on a flat surface, then the largest distance between the bottom surface of the glass article and the flat surface is recorded as warp. The warp may for example be measured by a set of feeler gauge, in particular with a resolution of 0.02 mm.

The glass article of the invention may have a warp of at least 0.5 mm, at least 1.0 mm, at least 1.5 mm, or at least 2.0 mm, in particular with the first surface of the glass article being the convex surface and the second surface of the glass article being the concave surface. The glass article of the invention may have a warp of at most 5.0 mm, at most 4.0 mm, at most 3.0 mm, or at most 2.5 mm, in particular with the first surface of the glass article being the convex surface and the second surface of the glass article being the concave surface. The glass article of the invention may have a warp in a range of from 0.5 to 5.0 mm, from 1.0 to 4.0 mm, from 1.5 to 3.0 mm, or from 2.0 to 2.5 mm, in particular with the first surface of the glass article being the convex surface and the second surface of the glass article being the concave surface. This warp is also referred to as absolute warp and indicates the warp of the glass article.

However, it is also possible to determine the relative warp of a glass article, in particular the area-relative warp and/or the length-relative warp.

The warp of the glass article may for example be indicated normalized to the surface area of one of the two main surfaces of the glass article (area-relative warp). Both main surfaces of the glass article generally have the same surface area or about the same surface area so that the warp can be normalized to any one of the two main surfaces with the same result. For example, each of the two main surfaces of a glass article having a length of 50 mm and a width of 30 mm has a surface area of 30×50 mm²=1500 mm². Likewise, each of the two main surfaces of a glass article having a length of 125 mm and a width of 40 mm has a surface area of 125×40 mm²=5000 mm². If such a glass article with a surface area of 5000 mm² of each of the two main surfaces had a warp of 2.0 mm (=2000 μm), the area-relative warp would be 2000 μm divided by 5000 mm², i.e. 0.4 μm per mm².

The glass article of the invention may have an area-relative warp of at least 0.02 μm per mm², at least 0.05 μm per mm², at least 0.10 μm per mm², or at least 0.25 μm per mm², in particular with the first surface of the glass article being the convex surface and the second surface of the glass article being the concave surface. The glass article of the invention may have an area-relative warp of at most 5.0 μm per mm², at most 2.5 μm per mm², at most 1.5 μm per mm², or at most 1.0 μm per mm², in particular with the first surface of the glass article being the convex surface and the second surface of the glass article being the concave surface. The glass article of the invention may have an area-relative warp in a range of from 0.02 to 5.0 μm per mm², from 0.05 to 2.5 μm per mm², from 0.10 to 1.5 μm per mm², or from 0.25 to 1.0 μm per mm², in particular with the first surface of the glass article being the convex surface and the second surface of the glass article being the concave surface.

The warp of the article may also be indicated normalized to the longest length of one of the two main surfaces of the glass article (length-relative warp). Both main surfaces of the glass article generally have the same longest length or about the same longest length so that the warp can be normalized to any one of the two main surfaces with the same result. For glass articles having main surfaces with round shape, the longest length is the diameter thereof. For glass articles having main surfaces with rectangular shape, the longest length is the diagonal thereof. For example, each of the two main surfaces of a glass article having a length of 50 mm and a width of 30 mm has a longest length of square root (30² mm²+50² mm²)≈58.3 mm. Likewise, each of the two main surfaces of a glass article having a length of 125 mm and a width of 40 mm has a longest length of (125² mm²+40² mm²)≈131.25 mm. If such a glass article with a longest length of 131.25 mm of each of the two main surfaces had a warp of 2.0 mm (=2000 μm), the length-relative warp would be 2000 μm divided by 131.25 mm, i.e. about 15.2 μm per mm.

The glass article of the invention may have a length-relative warp of at least 5.0 μm per mm, at least 10.0 μm per mm, at least 12.5 μm per mm, or at least 15.0 μm per mm, in particular with the first surface of the glass article being the convex surface and the second surface of the glass article being the concave surface. The glass article of the invention may have a length-relative warp of at most 50.0 μm per mm, at most 40.0 μm per mm, at most 30.0 μm per mm, or at most 20.0 μm per mm, in particular with the first surface of the glass article being the convex surface and the second surface of the glass article being the concave surface. The glass article of the invention may have a length-relative warp in a range of from 5.0 to 50.0 μm per mm, from 10.0 to 40.0 μm per mm, from 12.5 to 30.0 μm per mm, or from 15.0 to 20.0 μm per mm, in particular with the first surface of the glass article being the convex surface and the second surface of the glass article being the concave surface.

The present invention also relates to a method of processing a glass article having a first surface and a second surface, in particular a method of producing a glass article of the invention, the method comprising the following steps:
a) Providing a glass article
b) Forming a stack assembly comprising a plurality of glass articles (for example from 3 to 100, or from 4 to 20 glass articles) and at least one (preferably exactly one) adhesive layer between two adjacent glass articles, wherein the first surface of the glass article is in contact with a first adhesive layer comprising (or consisting of) a first adhesive and the second surface of the glass article is in contact with a second adhesive layer comprising (or consisting of) a second adhesive,
c) Contacting the stack assembly (or smaller stack assemblies obtained therefrom) with a first etching solution,
d) Delaminating the stack assembly (or the smaller stack assemblies obtained therefrom) by removing the first adhesive layer, wherein sandwich assemblies are obtained consisting of two glass articles and the second adhesive layer located between the two glass articles,
e) Contacting the sandwich assemblies with a second etching solution,
f) Delaminating the sandwich assemblies by removing the second adhesive layer.

The present invention also relates to a method of processing a plurality of glass articles having a first surface and a second surface, in particular a method of producing a glass article according to at least one of the preceding claims, the method comprising the following steps:
a) Providing a plurality of glass articles,
b) Forming a stack assembly comprising the plurality of glass articles and at least one adhesive layer between two adjacent glass articles, wherein the first surface of the glass articles is in contact with a first type of adhesive and the second surface of the glass articles is in contact with a second type of adhesive,
c) Contacting the stack assembly or smaller stack assemblies obtained therefrom with a first etching solution,
d) Delaminating the stack assembly or the smaller stack assemblies obtained therefrom by removing the first type of adhesive, wherein sandwich assemblies are obtained consisting of two glass articles and the second type of adhesive located between the two glass articles,
e) Contacting the sandwich assemblies with a second etching solution,
f) Delaminating the sandwich assemblies by removing the second type of adhesive.

Steps a) to f) are in particular performed in the given order. In particular, step a) is performed prior to step b), step b) is performed prior to step c), step c) is performed prior to step d), step d) is performed prior to step e), and/or step e) is performed prior to step f). This does not exclude that the method of the invention may comprise one or more additional steps subsequent to any of steps a) to f) described above.

Step a) of providing a glass article or a plurality of glass articles may for example comprise a down draw or overflow fusion process. However, it is also possible to subject glass articles not obtained by down draw or overflow fusion to the method of the present invention.

Step b) of forming a stack assembly utilizes two different kinds of adhesive, a first adhesive and a second adhesive. The present invention includes the consideration of protecting the second surface of the glass article(s) during the second etching step e) from being contacted with the second etching solution. In contrast, the first surface of the glass article(s) has to be in contact with the second etching solution in order to achieve slimming to the desired thickness of the glass article(s). Therefore, the first (type of) adhesive is preferably chosen such that it can be removed during delamination step d). This enables the first surface of the glass article(s) to be in contact with the second etching solution during step e). In contrast, the second (type of) adhesive is preferably chosen such that it is not removed during delamination step d). This enables the second surface of the glass article(s) to be protected from being in contact with the second etching solution during step e).

It will be appreciated that the choice of the first (type of) adhesive and of the second (type of) adhesive is largely determined by the particular delamination process chosen to be applied in step d). For example, if delamination step d) is chosen to include boiling the stack assembly in hot water for removal of the first adhesive layer, the first (type of) adhesive should be chosen such that it is removable by boiling in hot water, whereas the second (type of) adhesive should be chosen such that it is not removable by boiling in hot water. If another delamination method is applied in step d), the choice of the first (type of) adhesive and of the second (type of) adhesive is easily adapted accordingly. Differences of the first (type of) adhesive and of the second (type of) adhesive may not only be such that their removability is qualitatively different (for example the first (type of) adhesive being removable by hot water and the second (type of) adhesive not being removable by hot water). Alternatively or in addition, the first (type of) adhesive and the second (type of) adhesive may be differentiated by quantitative differences. For example, it may be considered that the first (type of) adhesive and the second (type of) adhesive may both be removable by the same principle of delamination, however, the second (type of) adhesive requiring a quantitatively higher amount of this principle of delamination, for example a higher concentration of a removing substance, a higher temperature, or the like.

Adhesives are often differentiated by their curing mechanism. For example, adhesives may be cured by applying energy in form of pressure, radiation, or the like. The first and/or the second (type of) adhesive of the present invention may for example be a pressure sensitive adhesive (PSA) or a UV curable adhesive. For example, the first (type of) adhesive may be a PSA and the second (type of) adhesive may be a UV curable adhesive. Alternatively, the first (type of) adhesive may be a UV curable adhesive and the second (type of) adhesive may be a PSA. In some embodiments, both the first (type of) adhesive and the second (type of) adhesive may be a PSA, or both the first (type of) adhesive and second (type of) adhesive may be a UV curable adhesive. It is particularly preferred that both the first (type of) adhesive and the second (type of) adhesive are a UV curable adhesive.

According to step c) of the method of the present invention, the stack assembly is contacted with a first etching solution. The etching time may for example be from 1 to 120 minutes, from 1 to 60 minutes, from 1 to 30 minutes, or from 1 to 20 minutes such as from 2 to 15 minutes or from 5 to 12 minutes. The etching time may for example be at least 1 minute, at least 2 minutes, at least 5 minutes, or at least 10 minutes. The etching time may for example be at most 120 minutes, at most 60 minutes, at most 30 minutes, at most 20 minutes, at most 15 minutes, or at most 12 minutes. Usually, the lower the thickness of the glass article(s) is, the lower etching time may be chosen.

The etching temperature may for example be from 1° C. to 80° C., or from 20° C. to 50° C. such as from 30° C. to 45° C.

The etchant solution preferably comprises or consists of a mixture of HF and/or NH₄HF₂ with an inorganic acid (for example HCl, HNO₃, H₂SO₄ or mixtures of two or more thereof) and/or with an organic acid (for example acetic acid, citric acid, oxalic acid or mixtures of two or more thereof). The total amount of HF and NH₄HF₂ may for example be in range of from 0.1 wt.-% to 10 wt.-% such as from 0.5 to 5 wt.-% or from 1 to 2 wt.-%. The total amount of HF and NH₄HF₂ may for example be at least 0.1 wt.-%, at least 0.5 wt.-% or at least 1 wt.-%. The total amount of HF and NH₄HF₂ may for example be at most 10 wt.-%, at most 5 wt.-% or at most 2 wt.-%. The weight ratio of the total amount of inorganic acid to the total amount of HF and NH₄HF₂ may for example be in a range of from 0.1:1 to 10:1. The weight ratio of the total amount of organic acid to the total amount of HF and NH₄HF₂ may for example be in a range of from 0.1:1 to 10:1. The etchant solution may for example comprise or consist of 3 wt.-% NH₄HF₂ and 3 wt.-% HNO₃, or the etchant solution may comprise or consist of 2 wt.-% NH₄HF₂, 2 wt.-% HNO3 and 5 wt.-% acetic acid, or the etchant solution may comprise or consist of 1 wt.-% HF and 1 wt.-% HNO₃. The etchant solution may comprise one or more surfactants, for example alkylphenol ethoxylate, or ammonium lauryl sulfate, or mixtures of alkylphenol ethoxylate and ammonium lauryl sulfate.

Notably, etching step c) is done prior to the first delamination step d). Therefore, both the first surface and the second surface of the glass article(s) is protected from being contacted with the first etching solution. Rather, the first etching solution contacts the edges of the glass articles. In particular, etching step c) may be a step of providing the at least one edge of the glass article(s) with a chamfer structure.

The method of the invention may optionally comprise one or more additional step(s) subsequent to forming the stack assembly according to step b) and prior to etching step c). For example, the stack assembly may be cut into smaller stack assemblies. The method of the invention may also comprise the step of edge grinding the stack assembly or smaller stack assemblies obtained therefrom prior to contacting the stack assembly with the first etching solution of step c).

The glass article or plurality of glass articles provided in step a) may have a comparably large length and/or width. For example, the glass article(s) provided in step a) may have a length of about 500 mm and/or a width of about 400 mm. Such dimensions may be too large for various intended applications such as the use of the glass article(s) of the invention in foldable electronic devices such as smartphones. Therefore, it may be desired to reduce the length and/or width by cutting the glass article(s) into smaller glass articles. Such a cutting step, if desired, is preferably done subsequent to step b) of forming a stack assembly and prior to etching step c). The optional cutting step results in smaller stack assemblies as compared to the stack assembly formed in step b). The term “smaller” refers to a reduced length and/or width of the stack assemblies obtained by the cutting step as compared to the length and/or width of the stack assembly formed in step b). For example, the optional cutting step may result in stack assemblies having a length of about 125 mm and a width of about 40 mm, or in stack assemblies having a length of about 50 mm and a width of about 30 mm.

According to step d) of the method of the present invention, the stack assembly (or the smaller stack assemblies obtained therefrom) is delaminated by removing the first adhesive layer or the first type of adhesive, respectively. This results in sandwich assemblies consisting of two glass articles and the second adhesive layer or second type of adhesive, respectively, located between the two glass articles. Delamination step d) may be adapted depending on the first and second (type of) adhesive applied in step b) of forming the stack assembly. The delamination step d) is chosen such that the first adhesive layer or first type of adhesive, respectively, is removed, whereas the second adhesive layer or second type of adhesive, respectively, is not removed. For example, delamination step d) may include keeping the stack assembly (or the smaller stack assemblies obtained therefrom) in a delaminating liquid at increased temperature. The temperature of the delaminating liquid may for example be above 40° C. The time of keeping in the delaminating liquid may for example be from 1 to 30 minutes. The delaminating liquid may for example be an aqueous solution, in particular water.

Additionally or alternatively, the stack assembly (or the smaller stack assemblies obtained therefrom) could be separated by physical force through the valley created by the two adjacent chamfers, in particular due to low adhesion strength between first adhesive layer and glass article(s).

According to step e) of the method of the present invention, the sandwich assemblies are contacted with a second etching solution. The second etching solution may for example comprise HF. The second etching solution may comprise inorganic acids and/or organic acids, in particular in addition to HF. Etching time, etching temperature and/or etching solution may be the same as described above for the first etching step.

The etching time may for example be from 1 to 120 minutes, from 1 to 60 minutes, from 1 to 30 minutes, or from 1 to 20 minutes such as from 2 to 15 minutes or from 5 to 12 minutes. The etching time may for example be at least 1 minute, at least 2 minutes, at least 5 minutes, or at least 10 minutes. The etching time may for example be at most 120 minutes, at most 60 minutes, at most 30 minutes, at most 20 minutes, at most 15 minutes, or at most 12 minutes. Usually, the lower the thickness of the glass article(s) is, the lower etching time may be chosen.

The etching temperature may for example be from 1° C. to 80° C., or from 20° C. to 50° C. such as from 30° C. to 45° C.

The etchant solution preferably comprises or consists of a mixture of HF and/or NH₄HF₂ with an inorganic acid (for example HCl, HNO₃, H₂SO₄ or mixtures of two or more thereof) and/or with an organic acid (for example acetic acid, citric acid, oxalic acid or mixtures of two or more thereof). The total amount of HF and NH₄HF₂ may for example be in range of from 0.1 wt.-% to 10 wt.-% such as from 0.5 to 5 wt.-% or from 1 to 2 wt.-%. The total amount of HF and NH₄HF₂ may for example be at least 0.1 wt.-%, at least 0.5 wt.-% or at least 1 wt.-%. The total amount of HF and NH₄HF₂ may for example be at most 10 wt.-%, at most 5 wt.-% or at most 2 wt.-%. The weight ratio of the total amount of inorganic acid to the total amount of HF and NH₄HF₂ may for example be in a range of from 0.1:1 to 10:1. The weight ratio of the total amount of organic acid to the total amount of HF and NH₄HF₂ may for example be in a range of from 0.1:1 to 10:1. The etchant solution may for example comprise or consist of 3 wt.-% NH₄HF₂ and 3 wt.-% HNO₃, or the etchant solution may comprise or consist of 2 wt.-% NH₄HF₂, 2 wt.-% HNO3 and 5 wt.-% acetic acid, or the etchant solution may comprise or consist of 1 wt.-% HF and 1 wt.-% HNO₃. The etchant solution may comprise one or more surfactants, for example alkylphenol ethoxylate, or ammonium lauryl sulfate, or mixtures of alkylphenol ethoxylate and ammonium lauryl sulfate.

According to step f) of the method of the invention, the sandwich assemblies are delaminated by removing the second adhesive layer or second type of adhesive, respectively. Glass articles of the invention may be obtained upon delamination step f). Step f) may be adapted depending on the second (type of) adhesive applied in step b) of forming the stack assembly. For example, delamination step f) may include applying irradiation to the sandwich assemblies, in particular UV irradiation. The radiation may for example have a peak wavelength in the range of from 250 nm to 450 nm, in particular from 300 nm to 400 nm, or from 350 to 395 nm, such as about 365 nm or 390 nm. The intensity of the irradiation may for example be from 200 to 1000 mJ/cm². The duration of the irradiation may for example be from 30 seconds to 30 minutes.

The method of the invention may further comprise the step of chemical toughening the glass article(s) obtained by delamination step f).

The present invention also relates to a bendable device comprising the glass article of the invention. In particular, the device may be bendable such that the first surface is located at the inner surface of the bend and the second surface is located the outer surface of the bend.

The bendable device may for example be bendable to a bending radius of from 1 to 5 mm, for example to a bending radius of 1 mm, of 2 mm, of 3 mm, of 4 mm, or of 5 mm.

The bendable device may for example be an electronic device, in particular a smartphone.

The present invention also relates to the use of the glass article of the invention in a bendable device, in particular in a bendable electronic device such as a smartphone.

Referring now to the drawings, FIG. 1 schematically shows the profile of a glass article 10 comprising a first surface 11, a second surface 12 and at least one edge connecting the first surface 11 and the second surface 12. The first surface 11 and the second surface 12 are essentially parallel to each other. The edge has a chamfer structure 16 comprising three surfaces, namely (i) a perpendicular surface 13 being essentially perpendicular to the first surface 11 and to the second surface 12, (ii) a primary connecting surface 14 connecting the perpendicular surface 13 and the first surface 11, and (iii) a secondary connecting surface 15 connecting the perpendicular surface 13 and the second surface 12. The chamfer structure 16 of the glass article 10 as shown in FIG. 1 is symmetrical.

FIG. 2 schematically shows the profile of a glass article 20 comprising a first surface 21, a second surface 22 and at least one edge connecting the first surface 21 and the second surface 22. The first surface 21 and the second surface 22 are essentially parallel to each other. The edge has a chamfer structure 26 comprising three surfaces, namely (i) a perpendicular surface 23 being essentially perpendicular to the first surface 21 and to the second surface 22, (ii) a primary connecting surface 24 connecting the perpendicular surface 23 and the first surface 21, and (iii) a secondary connecting surface 25 connecting the perpendicular surface 23 and the second surface 22. The chamfer structure 26 of the glass article 20 as shown in FIG. 2 is asymmetrical.

FIG. 3 shows a cross-sectional microscope image of a glass article having an asymmetric chamfer structure. The image was obtained with a magnification of 200×. The focus was on the top plane so that the edges look very sharp. The glass article was positioned such that the top plane is not tilted. Thus, the top plane was perpendicular to the direction of light. The images were obtained with automatic white balance, automatic brightness and automatic contrast using Nikon Y-TV55 microscope. Tangent lines were fitted to the relevant surfaces in the microscope image (tangent line A to the primary connecting surface, tangent line B to the first surface, tangent line C to the perpendicular surface, tangent line D to the secondary connecting surface, and tangent line E to the second surface). Fitting the tangent lines to respective surfaces was done by hand using ImageJ software (version 1.53i of Mar. 24, 2021). As also shown in FIG. 3, the secondary connecting surface, and even more pronounced the primary connecting surface was deviating from a straight line towards the transition into the second surface or into the first surface, respectively. Therefore, the tangent line was fitted such that the best fit was obtained towards transition of the primary connecting surface to the perpendicular surface whereas a larger deviation was acceptable towards the transition of the primary connecting surface to the first surface. The same was done analogously for fitting the tangent line to the secondary connecting surface. As shown in FIG. 3, the tangent line A to the primary connecting surface crosses the tangent line B to the first surface at a distance d₁ from the tangent line C to the perpendicular surface. Likewise, the tangent line D to the secondary connecting surface crosses the tangent line E to the second surface at a distance d₂ from the tangent line C to the perpendicular surface. Both d₁ and d₂ were measured perpendicular to the tangent line C to the perpendicular surface using ImageJ software. Measuring was done by comparing the lengths of distances d₁ and d₂, respectively, with the length of the 100 μm scale bar. The distance d₁ was measured to be 99 μm and the distance d₂ was measured to be 56 μm. The thickness of the glass article was 50 μm.

FIGS. 4A and 4B are schematic representations of the set-up of the ball-on-ring test not drawn to scale. FIG. 4A shows a top/bottom view of the set-up. FIG. 4B shows a cross-sectional view of the set-up. In the ball-on-ring test, surface 45 of a glass article 41 is placed on a steel ring 42 with an inner diameter of 4 mm and an outer diameter of 6 mm. The ring is 3 mm deep, and the wall of the ring is 1 mm thick with the tip of the wall having a semi-circle with a diameter of 1 mm as cross-section. A tungsten carbide ball 43 having a diameter of 1 mm is pressed against the surface 44 of the glass article 41 along the center axis of the ring, with a speed of 5 mm/min until the glass shutters. The force at failure is recorded as the ball-on-ring failure force.

### EXAMPLES

### Example 1

Ex. 1: Aluminosilicate glass pieces with the size of 40*125*0.05 mm³ processed from 400*500*0.07 mm³ glass mother sheets directly fabricated by down drawing. A stack of the mother sheets was formed with alternative layers of two types of acrylate-based UV curable glue. The stack was then cut into smaller stacks with the size of 40*125 mm². After edge grinding, polishing and chamfer shaping, the smaller stacks were then delaminated between the type #1 glue layers by boiling in hot water, wherein sandwich assemblies are obtained consisting of two glass articles and the second glue layer located between the two glass articles. The sandwich assemblies were then immersed in a mixture of HF and inorganic/organic acids, wherein the glass articles were slimmed from 0.07 to 0.05 mm. The assemblies were then delaminated between the type #2 glue layers by UV irradiation. The individual glass pieces were then chemically toughened in pure KNO₃ and followed by a subsequent light etching in a mixture of HF and inorganic/organic acids to remove <2 μm of thickness from each surface of the glass samples.

### Example 2

Ex. 2: Aluminosilicate glass pieces with the size of 30*50*0.03 mm³ processed from 400*500*0.07 mm³ glass mother sheets directly fabricated by down drawing. A stack of the mother sheets was formed with alternative layers of two types of acrylate-based UV curable glue. The stack was then cut into smaller stacks with the size of 30*50 mm². After edge grinding, polishing and chamfer shaping, the smaller stacks were then delaminated between the type #1 glue layers by boiling in hot water, wherein sandwich assemblies are obtained consisting of two glass articles and the second glue layer located between the two glass articles. The sandwich assemblies were then immersed in a mixture of HF and inorganic/organic acids, wherein the glass articles were slimmed from 0.07 to 0.03 mm. The assemblies were then delaminated between the type #2 glue layers by UV irradiation. The individual glass pieces were then chemically toughened in pure KNO₃ and followed by a subsequent light etching in a mixture of HF and inorganic/organic acids to remove <2 μm of thickness from each surface of the glass samples.

### Example 3

Ex. 3: Aluminosilicate glass pieces with the size of 30*50*0.07 mm³ processed from 400*500*0.1 mm³ glass mother sheets directly fabricated by down drawing. A stack of the mother sheets was formed with alternative layers of two types of acrylate-based UV curable glue. The stack was then cut into smaller stacks with the size of 30*50 mm². After edge grinding, polishing and chamfer shaping, the smaller stacks were then delaminated between the type #1 glue layers by boiling in hot water, wherein sandwich assemblies are obtained consisting of two glass articles and the second glue layer located between the two glass articles. The sandwich assemblies were then immersed in a mixture of HF and inorganic/organic acids, wherein the glass articles were slimmed from 0.1 to 0.07 mm. The assemblies were then delaminated between the type #2 glue layers by UV irradiation. The individual glass pieces were then chemically toughened in pure KNO₃ and followed by a subsequent light etching in a mixture of HF and inorganic/organic acids to remove <2 μm of thickness from each surface of the glass samples.

### Comparative Example 1

CEx. 1: Aluminosilicate glass pieces with the size of 40*125*0.05 mm³ processed from 400*500*0.07 mm³ glass mother sheets directly fabricated by down drawing. A stack of the mother sheets was formed with one type of acrylate-based UV curable glue. The stack was then cut into smaller stacks with the size of 40*125 mm². After edge grinding, polishing and chamfer shaping, the smaller stacks were then delaminated between the glue layers by boiling in hot water. The individual glass pieces were then slimmed from 0.07 to 0.05 mm by immersing in a mixture of HF and inorganic/organic acids. The slimmed individual glass pieces were then chemically toughened in pure KNO₃ and followed by a subsequent light etching in a mixture of HF and inorganic/organic acids to remove <2 μm of thickness from each surface of the glass samples.

### Comparative Example 2

CEx. 2: Aluminosilicate glass pieces with the size of 30*50*0.03 mm³ processed from 400*500*0.07 mm³ glass mother sheets directly fabricated by down drawing. A stack of the mother sheets was formed with one type of acrylate-based UV curable glue. The stack was then cut into smaller stacks with the size of 30*50 mm². After edge grinding, polishing and chamfer shaping, the smaller stacks were then delaminated between the glue layers by boiling in hot water. The individual glass pieces were then slimmed from 0.07 to 0.03 mm by immersing in a mixture of HF and inorganic/organic acids. The slimmed individual glass pieces were then chemically toughened in pure KNO₃ and followed by a subsequent light etching in a mixture of HF and inorganic/organic acids to remove <2 μm of thickness from each surface of the glass samples.

### Comparative Example 3

CEx. 3: Aluminosilicate glass pieces with the size of 30*50*0.07 mm³ processed from 400*500*0.1 mm³ glass mother sheets directly fabricated by down drawing. A stack of the mother sheets was formed with one type of acrylate-based UV curable glue. The stack was then cut into smaller stacks with the size of 30*50 mm². After edge grinding, polishing and chamfer shaping, the smaller stacks were then delaminated between the glue layers by boiling in hot water. The individual glass pieces were then slimmed from 0.1 to 0.07 mm by immersing in a mixture of HF and inorganic/organic acids. The slimmed individual glass pieces were then chemically toughened in pure KNO₃ and followed by a subsequent light etching in a mixture of HF and inorganic/organic acids to remove <2 μm of thickness from each surface of the glass samples.

### Experimental Results

The following table provides a summary of the examples described above and various properties thereof.

| | 1st surface: | 2nd surface: | | | Chamfer | |
|---|---|---|---|---|---|---|
| | CS (MPa)/ | CS (MPa)/ | 1st surface | 2nd surface | asymmetry | Warp |
| | DoL (μm) | DoL (μm) | Ra (pm) | Ra (pm) | (μm) | (mm) |
| Ex. 1 | 562/9.3 | 526/9.5 | 243 | 172 | ~40 | ~2 |
| Ex. 2 | 469/6.4 | 436/6.7 | 283 | 184 | ~55 | ~1 |
| Ex. 3 | 612/11.1 | 571/11.3 | 238 | 175 | ~64 | ~1 |
| CEx. 1 | 553/9.3 | 545/9.3 | 234 | 241 | <10 | ~0 |
| CEx. 2 | 455/6.5 | 443/6.5 | 256 | 272 | <10 | ~0 |
| CEx. 3 | 591/11.1 | 603/11.1 | 258 | 226 | <10 | ~0 |

The examples of the invention (Ex. 1 to Ex. 3) have a pronounced asymmetry in several aspects as compared to the comparative examples (CEx. 1 to CEx. 3). The comparative examples were designed to match the corresponding examples (CEx. 1 matches Ex. 1; CEx. 2 matches Ex. 2; CEx. 3 matches Ex. 3) except for the comparative examples not being produced from stack assemblies with two different adhesives. Therefore, the second surface of Ex. 1 to Ex. 3 was protected from being contacted by the etching solution during the slimming step whereas the second surface of CEx. 1 to CEx. 3 was not protected during slimming. Protection of the second surface during slimming resulted in various asymmetries observed in Ex. 1 to Ex. 3 but not in CEx. 1 to CEx. 3.

### a) Surface Roughness

The second surface had a pronouncedly reduced surface roughness Rₐ in examples Ex. 1 to Ex. 2 as compared to the first surface thereof in contrast to the comparative examples in which this difference was not observed. Surface roughness Rₐ was measured by Atomic Force Microscope (AFM). Model: BRUKER's Dimension Icon. Area: 10*10 μm. Surface roughness Rₐ was determined according to DIN EN ISO 4287:2010-07.

### b) Chamfer Asymmetry

The chamfer structure of examples Ex. 1 to Ex. 3 was strongly asymmetric. In contrast, such asymmetry was not observed in the comparative examples.

Symmetry/asymmetry of the chamfer structure was assessed as illustrated in FIGS. 1 to 3 based on an image of a cross-section of a profile of a chamfer structure as shown in FIG. 3. In order to obtain such images, the glass articles were observed with an optical microscope in transmitted light mode. A 200× magnification was used. The focus was on the top plane so that the edges looked very sharp. The glass articles were positioned such that the top plane was not tilted. Thus, the top plane was perpendicular to the direction of light. Images of particularly good quality were obtained with automatic white balance, automatic brightness and automatic contrast using Nikon Y-TV55 microscope.

As exemplarily shown in FIG. 3, tangent lines were fitted to the relevant surfaces in the microscope image (tangent line A to the primary connecting surface, tangent line B to the first surface, tangent line C to the perpendicular surface, tangent line D to the secondary connecting surface, and tangent line E to the second surface). Fitting the tangent lines to respective surfaces was be done by hand using ImageJ software.

As shown in FIG. 3, the tangent line A to the primary connecting surface crosses the tangent line B to the first surface at a distance d₁ from the tangent line C to the perpendicular surface. Likewise, the tangent line D to the secondary connecting surface crosses the tangent line E to the second surface at a distance d₂ from the tangent line C to the perpendicular surface. Both d₁ and d₂ were measured perpendicular to the tangent line C to the perpendicular surface as also illustrated in FIG. 3. The length of distances d₁ and d₂ were measured using ImageJ software by comparing the lengths of distances d₁ and d₂, respectively, with the length of the scale bar.

The asymmetry value referred to in the table above is the absolute value of the difference d₁−d₂. For examples Ex. 1 to Ex. 3, this difference was from 40 to 64 μm, respectively. In contrast, for the comparative examples, this difference was smaller than 10 μm.

### c) Chemical Toughening

The asymmetry of glass articles of the invention regarding their first and second surface is also reflected by an asymmetry upon chemical toughening.

As shown in the table above, the first surface of Ex. 1 to Ex. 3 is associated with higher surface compressive stress (CS) but lower depth (DoL) of the compressive stress layer as compared to the second surface of the glass article. Such differences were not observed in the comparative examples.

Interestingly, differences of first and second surface regarding the results of chemical toughening were associated with occurrence of warp in Ex. 1 to Ex. 3 as also indicated in the table above. Warp was not observed in the comparative examples. The warp was measured by placing the glass article on a flat surface, then the largest distance between the bottom surface of the glass article from the flat surface was recorded as warp. It is typically at one of the four corners. The distance was measured by a set of feeler gauge (resolution was 0.02 mm). The warp data shown in the table above are referring to the whole sample area, i.e. 40×125 mm² or 30×50 mm², respectively.

The warp of Ex. 1 to Ex. 3 was such that the first surface of the glass article was convex and the second surface of the glass article was concave.

### d) Pen Drop Height

The breakage height is determined in a pen drop test in which the glass article is attached with one surface to a 150 μm thick substrate, which consists of, from the side contacting the glass to the side contacting the marble stage, a 25 μm thick layer of pressure sensitive adhesive (PSA) material, a 50 μm thick layer of polyethylene (PE), another 25 μm thick layer of pressure sensitive adhesive (PSA), and another 50 μm thick layer of polyethylene (PE). Beneath the 150 μm thick substrate, there is a flat 10 cm thick marble stage, with polished smooth surface. The other surface of the glass article facing upwards is then subsequently impacted with a 14 g ball point pen (Made by Chenguang) with the 0.5 mm diameter ball made from tungsten carbide, with increasing height from 5 mm until the glass breaks. The failure height is then recorded as the pen drop height.

The output of the pen drop test is the pen drop height of the surface that is impacted with the ball point pen. Due to the pronounced dependence of the pen drop height on the thickness of the article, it may be considered to refer to the normalized pen drop height for comparing the properties of articles of different thickness. The normalized pen drop height was obtained as the ratio of the pen drop height (in μm) and the square of the article thickness (in μm²). The results are shown in the following table.

| | | | Normalized pen | | Ratio 1^{st}/2^{nd} |
|---|---|---|---|---|---|
| | Pen drop height | | drop height | | (normalized |
| | 1st | 2nd | 1st | 2nd | pen drop |
| | surface | surface | surface | surface | height) |
| Ex. 1 | 18.9 mm | 13.2 mm | 7.6 per μm | 5.3 per μm | 1.43 |
| Ex. 2 | 8.2 mm | 6.1 mm | 9.1 per μm | 6.8 per μm | 1.34 |
| Ex. 3 | 53.3 mm | 41.0 mm | 10.9 per μm | 8.4 per μm | 1.30 |

The values of the pen drop height in the tables above are the mean values of 15 experiments. The standard deviation was 1.2 mm for Ex. 1, 1.3 mm for Ex. 2, and 2.2 mm for Ex. 3.

The data show that the pen drop height of the first surface was strongly increased. In contrast, the pen drop height of the comparative examples was comparable to the pen drop height of the second surface of Ex. 1 to Ex. 3 (CEx. 1:12.9 mm; CEx. 2:6.1 mm; CEx. 3:39.5 mm).

### e) 2PB Strength

In the 2-point bending test (2PB test), the glass article is placed as a U-shape between two parallel metal plates. The two plates are big enough to cover the whole glass article. Then one of the plate moves towards the other one while remaining parallel with a speed of 60 mm/min until the glass article breaks. The 2PB strength is calculated by:

$$σ = \frac{1.1 \; 98 Ed}{D - d}$$

where σ is the calculated strength; E is the Young's modulus; d is the glass article thickness; D is the distance between the two plates at failure.

The output of the 2PB test is the 2PB strength of the surface of the glass article that represented the outer surface of the bend. For example, if the glass article was bent such that the second surface of the glass article was the outer surface of the bend whereas the first surface of the glass article was the inner surface of the bend, the output of the 2PB test is the 2PB strength of second surface of the glass article.

The following table shows the 2PB strength (in MPa) of Ex. 1 to Ex. 3 in the 2PB test.

| | 1st surface | 2nd surface | Ratio 2^{nd}/1^{st} |
|---|---|---|---|
| Ex. 1 | 2614 MPa | 2983 MPa | 1.14 |
| Ex. 2 | 2393 MPa | 2956 MPa | 1.24 |
| Ex. 3 | 2519 MPa | 3049 MPa | 1.21 |

The values of the 2PB strength in the table above are the mean values of 30 experiments. The data show that the 2PB strength of the second surface was strongly increased by protecting the second surface from the etching solution during the slimming step. In contrast, this was not observed in the comparative examples because the second surface was not protected. In fact, the 2PB strength of the comparative examples was comparable to the 2PB strength of the first surface of Ex. 1 to Ex. 3 (CEx. 1:2570 MPa; CEx. 2:2438 MPa; CEx. 3:2451 MPa).

### f) Ball-On-Ring (BoR) Test:

In the BoR test, the glass article is placed on a steel ring with the inner diameter of 4 mm and outer diameter of 6 mm. The ring is 3 mm deep, and wall of the ring is 1 mm thick with the tip of the wall has a 1 mm diameter semi-circle as cross-section. The edges of the glass sample were at least 20 mm away from the center of the ring. A 1 mm diameter tungsten carbide ball is then pressed against the glass sample along the center axis of the ring, with the speed of 5 mm/min until the glass shutters. The force at failure is recorded. The setup of the BoR test is schematically shown in FIGS. 4A and 4B.

Depending on which of the surfaces of the glass article is contacted with the ring or with the ball, respectively, the ball-on-ring failure force of the first surface or of the second surface of glass article can be tested. The ball-on-ring test as described herein is adjusted for determining the ball-on-ring failure force of that particular surface of the glass article that is in contact with the steel ring. Notably, it is this surface of the glass article that experiences tensile forces during the ball-on-ring test. Therefore, the output of the ball-on-ring test is the ball-on-ring failure force of the surface that is in contact with the steel ring.

The following table shows the BoR failure force (in N) of Ex. 1 to Ex. 3 in the BoR test.

| | 1st surface | 2nd surface | Ratio 2^{nd}/1^{st} |
|---|---|---|---|
| Ex. 1 | 9.1N | 11.4N | 1.25 |
| Ex. 2 | 8.0N | 10.0N | 1.25 |
| Ex. 3 | 12.7N | 15.1N | 1.19 |

The values of the BoR failure force in the table above are the mean values of 15 experiments. The data show that the BoR failure force of the second surface was strongly increased by protecting the second surface from the etching solution during the slimming step. In contrast, this was not observed in the comparative examples because the second surface was not protected. In fact, the BoR failure force of the comparative examples was comparable to the BoR failure force of the first surface of the corresponding Ex. 1 to Ex. 3 (CEx. 1:9.3 N; CEx. 2:8.2 N; CEx. 3:12.6 N).

### LIST OF REFERENCE SIGNS

10, 20 glass article
11, 21 first surface
12, 22 second surface
13, 23 perpendicular surface
14, 24 primary connecting surface
15, 25 secondary connecting surface
16, 26 chamfer structure
41 glass article
42 ring
43 ball
44, 45 surfaces of the glass article

1-45. (canceled)

46. A glass article having a thickness of from 10 μm to 150 μm, the glass article comprising:
a first surface;
a second surface, wherein a surface roughness Ra (arithmetic average roughness) of the second surface is at most 0.30 nm; and
at least one edge connecting the first surface and the second surface.

47. The glass article of claim 46, wherein a surface roughness Ra of the first surface is at most 0.80 nm.

48. The glass article of claim 46, wherein a surface roughness Ra of the first surface is higher than the surface roughness Ra of the second surface.

49. The glass article of claim 46, wherein an absolute value of a difference of a surface roughness Ra of the first surface and the surface roughness Ra of the second surface is at least 0.05 nm.

50. A glass article having a thickness of from 10 μm to 150 μm, the glass article comprising:
a first surface;
a second surface, wherein the first surface and the second surface are essentially parallel to each other; and
at least one edge connecting the first surface and the second surface, wherein the at least one edge has a chamfer structure comprising three surfaces comprising a perpendicular surface being essentially perpendicular to the first surface and to the second surface, a primary connecting surface connecting the perpendicular surface and the first surface, and a secondary connecting surface connecting the perpendicular surface and the second surface, wherein the chamfer structure has a profile such that a tangent line A to the primary connecting surface crosses a tangent line B to the first surface at a distance d1 from a tangent line C to the perpendicular surface and a tangent line D to the secondary connecting surface crosses a tangent line E to the second surface at a distance d2 from the tangent line C to the perpendicular surface, wherein both d1 and d2 are measured perpendicular to the tangent line C to the perpendicular surface, wherein tangent lines A, B, C, D, and E are obtained by fitting a respective tangent line to the corresponding surface in a profile of the chamfer structure, wherein the chamfer structure is asymmetric such that d1≠d2.

51. The glass article of claim 50, wherein an absolute value of a difference d1−d2 is at least 30% of the thickness of the glass article.

52. The glass article of claim 50, wherein an absolute value of a difference d1−d2 is at most 200% of the thickness of the glass article.

53. The glass article of claim 50, wherein an absolute value of a difference d1−d2 is at least 15 μm.

54. The glass article of claim 50, wherein an absolute value of a difference d1−d2 is at most 100 μm.

55. The glass article of claim 50, wherein d1 is in a range of from 50 to 200 μm.

56. The glass article of claim 50, wherein d2 is in a range of from 30 to 100 μm.

57. The glass article of claim 50, wherein d1 is larger than d₂.

58. A glass article having a thickness of from 10 μm to 150 μm, the glass article comprising:
a first surface having an impact resistance corresponding to a pen drop height of at least 5 mm;
a second surface having a ball-on-ring failure force of at least 5.0 N and/or a 2-point bending strength of at least 2,000 MPa; and
at least one edge connecting the first surface and the second surface.

59. The glass article of claim 58, wherein the first surface has an impact resistance corresponding to a normalized pen drop height of at least 4.5 per μm.

60. The glass article of claim 58, wherein a ratio of the pen drop height of the first surface and a pen drop height of the second surface is at least 1.05.

61. The glass article of claim 58, wherein a ratio of the ball-on-ring failure force of the second surface and a ball-on-ring failure force of the first surface is at least 1.05.

62. The glass article of claim 58, wherein a ratio of the 2-point bending strength of the second surface and a 2-point bending strength of the first surface is at least 1.05.

63. The glass article of claim 58, wherein the glass article is chemically toughened.

64. The glass article of claim 63, wherein a surface compressive stress CS1 at the first surface of the glass article and a surface compressive stress CS2 at the second surface of the glass article are each at least 300 MPa.

65. A method of processing a plurality of glass articles each having a first surface and a second surface, the method comprising:
providing a plurality of glass articles;
forming a stack assembly comprising the plurality of glass articles and at least one adhesive layer between two adjacent glass articles of the stack assembly, wherein the first surface of the glass articles is in contact with a first type of adhesive and the second surface of the glass articles is in contact with a second type of adhesive;
contacting the stack assembly or smaller stack assemblies obtained therefrom with a first etching solution;
delaminating the stack assembly or the smaller stack assemblies obtained therefrom by removing the first type of adhesive, wherein sandwich assemblies are obtained consisting of two glass articles and the second type of adhesive located between the two glass articles;
contacting the sandwich assemblies with a second etching solution; and
delaminating the sandwich assemblies by removing the second type of adhesive.
